(19) United States
(12) Patent Application Publication
(10) Pub. No.: US 2026/0243220 A1
(43) Pub. Date: Aug. 20, 2026

(54) Valve Mechanism and Fuel Pump

(71) Applicant: Astemo, Ltd., Chiyoda-ku, Tokyo (JP)

(72) Inventors: Tatsuo KAWANO, Hitachinaka-shi, Ibaraki (JP); Satoshi USUI, Hitachinaka-shi, Ibaraki (JP); Minoru HASHIDA, Hitachinaka-shi, Ibaraki (JP)

(21) Appl. No.: 19/164,278

(22) PCT Filed: Mar. 28, 2023
(86) PCT No.: PCT/JP2023/012433

§ 371 Date: Sep. 11, 2025

(51) Int. Cl. F02M 59/34

(52) U.S. Cl. CPC F02M 59/34

(57) ABSTRACT

Provided are a valve mechanism and a fuel pump that suppress erosion in a seat portion. The valve mechanism is disposed in a housing hole for passing a fuel therethrough. A seat member in the valve mechanism includes a fitting portion in intimate contact with an inner wall surface of the housing hole, a seat portion forming an enlarged space between the seat portion and the inner wall surface of the housing hole, and a fuel path penetrating the fitting portion and the seat portion for causing the fuel to pass therethrough. The valve body is adapted to face the seat portion and to open and close the fuel path. The valve holder is adapted to hold the valve body. The spring is adapted to bias the valve body toward the seat member with the valve holder interposed therebetween. In a state where the valve body is in contact with the seat portion by being biased by the spring, a tangential line passing through a point at which the valve body contacts the seat portion intersects with the valve holder at an intersection point, and a line extended in the axial direction of the housing hole from the intersection point passes through the enlarged space until the line reaches a surface of the seat member.

### TECHNICAL FIELD

The present invention relates to a valve mechanism and a fuel pump.

### BACKGROUND ART

A high-pressure fuel supply pump is described in, for example, PTL 1. The high-pressure fuel supply pump described in PTL 1 includes a relief-valve mechanism. The relief-valve mechanism includes a relief valve, and a relief spring for biasing the relief valve with a relief-valve holder interposed therebetween. The relief valve is pressed against a seat member by the biasing force of the relief spring, thereby closing a fuel path in the seat member. This blocks the movement of a fuel through the fuel path.

On the other hand, if the pressure of the fuel in a common rail or in a member ahead thereof increases to equal to or higher than a certain value, the fuel in the fuel path in the seat member presses the relief valve. Further, if the pressing force generated by the pressure of the fuel exceeds the biasing force of the relief spring, the relief valve moves against the biasing force of the relief spring. Consequently, the relief-valve mechanism opens, and the fuel in a discharge path returns to a pressurizing chamber through the fuel path in the seat member.

### CITATION LIST

### Patent Literature

PTL 1: JP 2020-133490 A

### SUMMARY OF INVENTION

### Technical Problem

On the other hand, in recent years, fuel pumps have been required to increase the pressure (fuel pressure) applied to the fuel. However, in the relief-valve mechanism described in PTL 1, if the fuel pressure increases, this induces a large decrease in the fuel pressure in the vicinity of the seat portion, when the fuel passes in the vicinity of the seat portion, when the valve is opened. As a result, cavitation around the seat portion induces air bubbles, and these air bubbles are crushed in the vicinity of the seat portion, thereby causing erosion in the seat portion.

In consideration of the above problems, it is an object of the present invention to provide a valve mechanism and a fuel pump that suppress erosion in a seat portion.

### Solution to Problem

In order to solve the aforementioned problem and to achieve the present object, a valve mechanism according to the present invention is disposed in a housing hole for passing a fuel therethrough. The valve mechanism includes a seat member, a valve body, a valve holder, and a spring. The seat member includes a fitting portion in intimate contact with an inner wall surface of the housing hole, a seat portion forming an enlarged space between the seat portion and the inner wall surface of the housing hole, and a fuel path penetrating the fitting portion and the seat portion for causing the fuel to pass therethrough. The valve body is adapted to face the seat portion and to open and close the fuel path. The valve holder is adapted to hold the valve body. The spring is adapted to bias the valve body toward the seat member with the valve holder interposed therebetween. A distance in the enlarged space in a radial direction of the housing hole, and a distance in the enlarged space in an axial direction of the housing hole are longer than a shortest distance between the seat portion and the valve holder. Further, in a state where the valve body is in contact with the seat portion by being biased by the spring, a tangential line passing through a point at which the valve body contacts the seat portion intersects with the valve holder at an intersection point, and a line extended in the axial direction of the housing hole from the intersection point passes through the enlarged space until the line reaches a surface of the seat member.

Further, the fuel pump according to the present invention includes a body having the housing hole for passing the fuel therethrough, and the aforementioned valve mechanism disposed in the housing hole.

### Advantageous Effects of Invention

According to the valve mechanism and the fuel pump having the aforementioned configurations, it is possible to suppress erosion in the seat portion.

Other problems, configurations, and effects than those described above will be clarified by the following description of an embodiment.

### BRIEF DESCRIPTION OF DRAWINGS

FIG. 1 is a view of an overall configuration of a fuel supply system using a high-pressure fuel supply pump according to an embodiment of the present invention.

FIG. 2 is a longitudinal cross-sectional view (part 1) of the high-pressure fuel supply pump according to the embodiment of the present invention.

FIG. 3 is a longitudinal cross-sectional view (part 2) of the high-pressure fuel supply pump according to the embodiment of the present invention.

FIG. 4 is a horizontal cross-sectional view of the high-pressure fuel supply pump according to the embodiment of the present invention, as viewed from above.

FIG. 5 is an enlarged view of a relief-valve mechanism according to the embodiment of the present invention.

FIG. 6 is an enlarged view of the vicinity of a seat portion in the relief-valve mechanism according to the embodiment of the present invention.

FIG. 7 is an enlarged view of the vicinity of the seat portion in the relief-valve mechanism according to the embodiment of the present invention.

### DESCRIPTION OF EMBODIMENTS

### 1. First Embodiment

Hereinafter, a high-pressure fuel supply pump according to an embodiment of the present invention will be described. In the drawings, the same members are denoted by the same reference numerals.

### [Fuel Supply System]

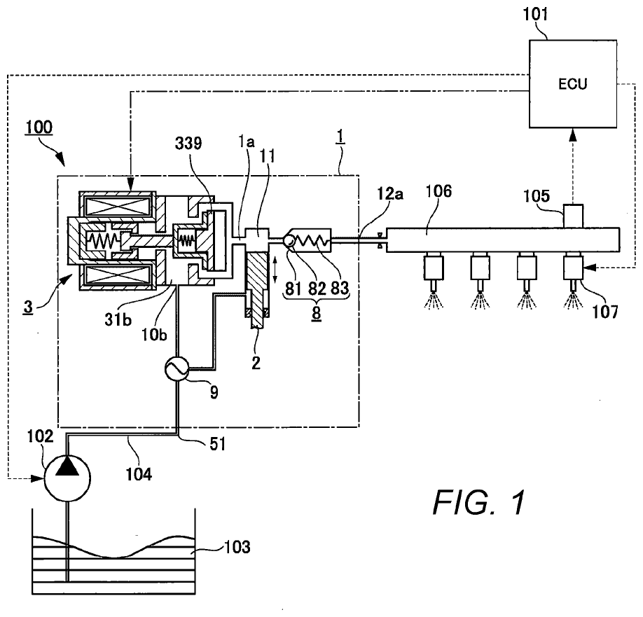

First, there will be described a fuel supply system using the high-pressure fuel supply pump according to the present embodiment, with reference to FIG. 1.

FIG. 1 is a view of an overall configuration of the fuel supply system using the high-pressure fuel supply pump according to the present embodiment.

As illustrated in FIG. 1, the fuel supply system includes a high-pressure fuel supply pump (fuel pump) 100, an engine control unit (ECU) 101, a fuel tank 103, a common rail 106, and a plurality of injectors 107. The components of the high-pressure fuel supply pump 100 are integrally incorporated in a body 1.

A fuel in the fuel tank 103 is pumped up by a feed pump 102, which is driven based on a signal transmitted from the ECU101. The fuel pumped up thereby is pressurized to an appropriate pressure by a pressure regulator (not illustrated). The pressurized fuel is sent to a low-pressure fuel suction port 51 of the high-pressure fuel supply pump 100 through a low-pressure pipe 104.

The high-pressure fuel supply pump 100 pressurizes the fuel supplied from the fuel tank 103 and pressure-feeds the fuel to the common rail 106. The plurality of injectors 107 and a fuel pressure sensor 105 are mounted on the common rail 106.

The plurality of injectors 107 are mounted thereon in correspondence with the number of cylinders (combustion chambers) The plurality of injectors 107 injects the fuel according to a driving electric current outputted from the ECU101. The fuel supply system according to the present embodiment is a so-called direct-injection engine system adapted to cause the injectors 107 to directly inject the fuel into the cylinder tubes in the engine.

The fuel pressure sensor 105 outputs detected pressure data to the ECU101. The ECU101 calculates an appropriate amount of fuel injection (target length of fuel injection), an appropriate fuel pressure (target fuel pressure), and the like, based on engine state quantities (for example, a crank rotation angle, a throttle opening, an engine speed, a fuel pressure, and the like) obtained from various sensors.

The ECU101 controls driving of the plurality of injectors 107 and the high-pressure fuel supply pump 100, based on the results of calculations of the fuel pressure (target fuel pressure) and the like. Namely, the ECU101 includes a pump control unit that controls the high-pressure fuel supply pump 100, and an injector control unit that controls the injectors 107.

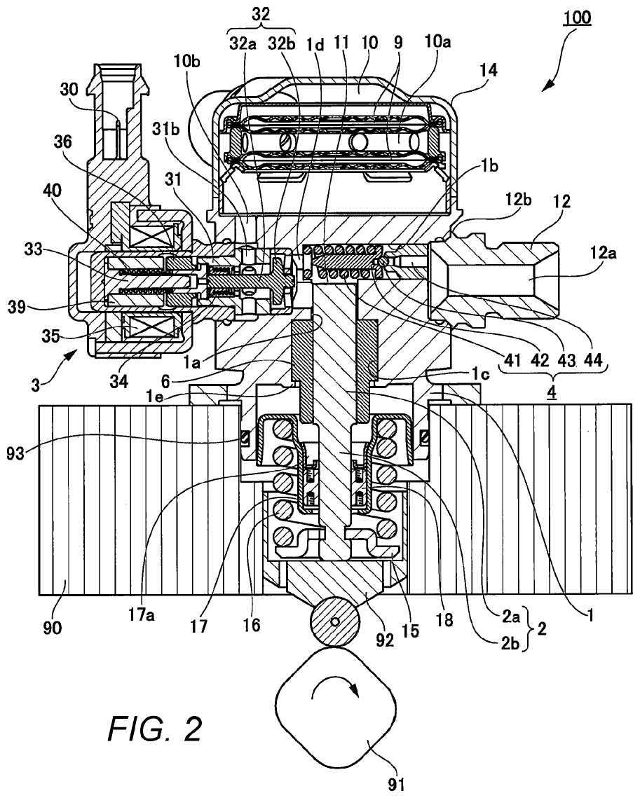

The high-pressure fuel supply pump 100 includes a pressure pulsation reduction mechanism 9, an electromagnetic suction-valve mechanism 3 which is a variable capacity mechanism, a relief-valve mechanism 4 (see FIG. 2), and a discharge-valve mechanism 8. The fuel flowing thereinto through the low-pressure fuel suction port 51 reaches a suction port 31b in the electromagnetic suction-valve mechanism 3, through the pressure pulsation reduction mechanism 9 and a suction path 10b.

The fuel flowing into the electromagnetic suction-valve mechanism 3 passes through a suction valve 32, flows through a suction path 1d formed in the body 1, and then flows into a pressurizing chamber 11. A plunger 2 is slidably held in the pressurizing chamber 11. A motive force is transmitted to the plunger 2 through a cam 91 (see FIG. 2) in the engine, so that the plunger 2 reciprocates.

The fuel is sucked into the pressurizing chamber 11 from the electromagnetic suction-valve mechanism 3 during the descending stroke of the plunger 2. The fuel sucked into the pressurizing chamber 11 is pressurized during the ascending stroke. If the fuel pressure in the pressurizing chamber 11 exceeds a set value, the discharge-valve mechanism 8 opens. Consequently, the high-pressure fuel is pressure-fed to the common rail 106 through a fuel discharge port 12a. The discharge of the fuel by the high-pressure fuel supply pump 100 is manipulated by opening and closing the electromagnetic suction-valve mechanism 3. The opening and closing of the electromagnetic suction-valve mechanism 3 is controlled by the ECU101.

### [The High-Pressure Fuel Supply Pump]

Next, the configuration of the high-pressure fuel supply pump 100 will be described with reference to FIGS. 2 to 4.

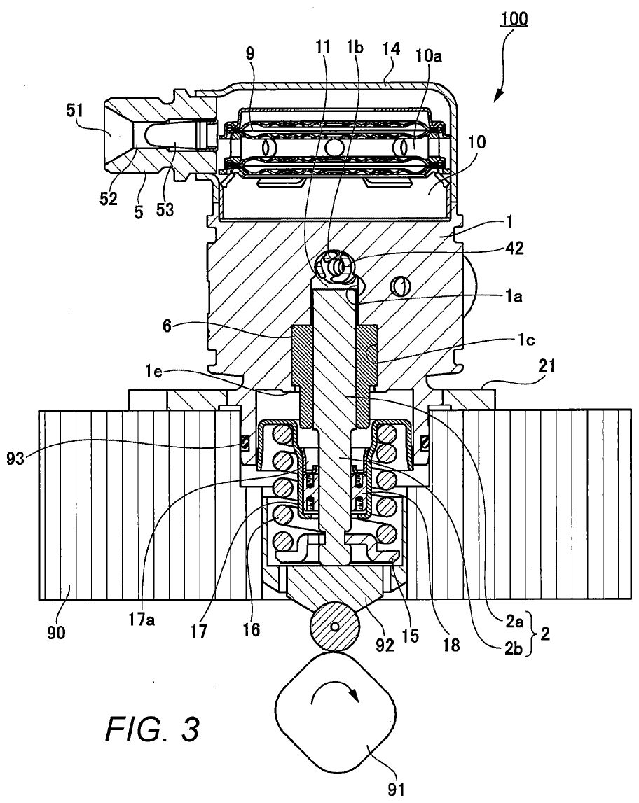

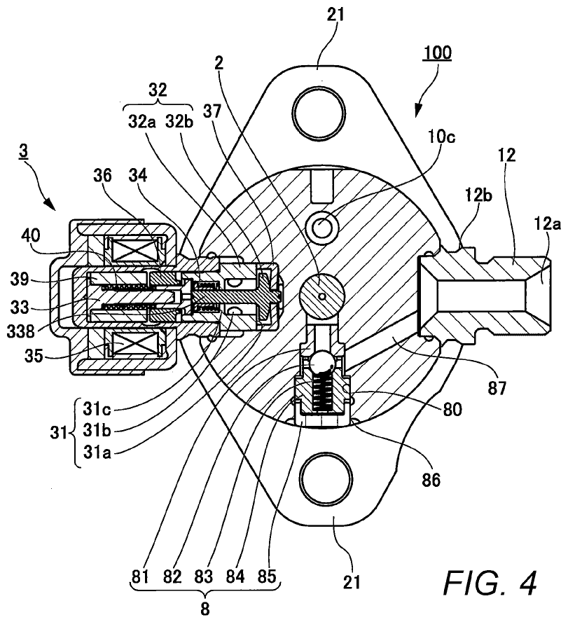

FIG. 2 is a longitudinal cross-sectional view of the high-pressure fuel supply pump 100. FIG. 3 is a longitudinal cross-sectional view of the high-pressure fuel supply pump 100 as viewed in a direction different from that of FIG. 2. FIG. 4 is a horizontal cross-sectional view of the high-pressure fuel supply pump 100 as viewed along a cross section orthogonal to the vertical direction.

As illustrated in FIGS. 2 to 4, the pump body 1 of the high-pressure fuel supply pump 100 is formed in a substantially columnar shape. As illustrated in FIGS. 2 and 3, the pump body 1 is interiorly provided with a first chamber 1a, a second chamber 1b, a third chamber 1c, and the suction path 1d.

The first chamber 1a is a columnar-shaped space portion provided in the pump body 1. The first chamber 1a has a center line 1A, which coincides with a center line of the pump body 1. One end portion of the plunger 2 is inserted in the first chamber 1a. The plunger 2 reciprocates in the first chamber 1a. The first chamber 1a and the one end of the plunger 2 form the pressurizing chamber 11.

The suction path 1d communicates with the pressurizing chamber 11. The fuel having passed through the electromagnetic suction-valve mechanism 3 is sucked into the pressurizing chamber 11 through the suction path 1d.

The second chamber 1b is a columnar-shaped space portion provided in the pump body 1. The second chamber 1b has a center line orthogonal to the center line of the pump body 1 (the first chamber 1a). The second chamber 1b corresponds to a housing hole according to the present invention. The relief-valve mechanism 4 is disposed in the second chamber 1b. The second chamber 1b is disposed above the first chamber 1a. The second chamber 1b communicates with one end (an upper end) of the first chamber 1a.

The third chamber 1c is a columnar-shaped space portion provided in the pump body 1. The third chamber 1c is continuous with the other end (the lower end) of the first chamber 1a. The third chamber 1c has a center line coinciding with the center line 1A of the first chamber 1a, and the center line of the pump body 1. The third chamber 1c has a diameter larger than the diameter of the first chamber 1a. A cylinder 6 for guiding the reciprocation of the plunger 2 is disposed in the third chamber 1c.

The cylinder 6 is formed in a tubular shape. The outer peripheral portion of the cylinder 6 is press-fitted in the third chamber 1c in the body 1. The cylinder 6 is in contact, at an end surface thereof, with a step portion between the first chamber 1a and the third chamber 1c. This can prevent the cylinder 6 from being displaced toward the first chamber 1a. The cylinder 6 guides the reciprocation of the plunger 2.

The body 1 is provided with a fixing portion 1e that engages with a center portion of the cylinder 6 in the axial direction. The fixing portion 1e in the body 1 presses the cylinder 6 upward (upward in FIG. 2). This can prevent the fuel having been pressurized in the pressurizing chamber 11 from leaking from between the upper end surface of the cylinder 6 and the body 1.

As illustrated in FIG. 3, a mounting flange 21 is bonded to the body 1. The mounting flange 21 is in intimate contact with a fuel-pump attachment portion 90 in the engine (internal combustion engine). The mounting flange 21 is mounted to the fuel-pump attachment portion 90 using bolts (screws). Namely, the high-pressure fuel supply pump 100 is fixed to the fuel-pump attachment portion 90 through the mounting flange 21.

As illustrated in FIGS. 2 and 3, between the fuel-pump attachment portion 90 and the body 1, there is interposed an O-ring 93, which represents a concrete example of a seat member. The O-ring 93 prevents an engine oil from leaking to the outside of the engine (internal combustion engine) through between the fuel-pump attachment portion 90 and the body 1.

A tappet 92 is provided on the lower end of the plunger 2. The tappet 92 converts rotational motion of the cam 91 attached to a cam shaft in the engine into upward and downward motion and transmits the upward and downward motion to the plunger 2. The plunger 2 is biased toward the cam 91 by a spring 16 with a retainer 15 interposed therebetween. Thus, the plunger 2 is in press-contact with the tappet 92. The tappet 92 reciprocates along with the rotation of the cam 91. The plunger 2 reciprocates together with the tappet 92, thereby changing the volume of the pressurizing chamber 11.

A seal holder 17 is disposed between the cylinder 6 and the retainer 15. The seal holder 17 is formed in a tubular shape which allows the plunger 2 to be inserted therethrough. An auxiliary chamber 17a is formed between an upper portion of the seal holder 17 and the pump body 1. Further, the seal holder 17 holds a plunger seal 18 at its lower end portion closer to the retainer 15.

The plunger seal 18 is slidably in contact with the outer periphery of the plunger 2. When the plunger 2 reciprocates, the plunger seal 18 seals the fuel in the auxiliary chamber 17a, thereby preventing the fuel in the auxiliary chamber 17a from flowing into the inside of the engine. Further, the plunger seal 18 prevents a lubricating oil (including an engine oil) for lubricating sliding portions in the engine from flowing into the inside of the body 1.

In FIG. 2, the plunger 2 reciprocates in the upward and downward direction. When the plunger 2 descends, the volume of the pressurizing chamber 11 increases, and when the plunger 2 ascends, the volume of the pressurizing chamber 11 decreases. Namely, the plunger 2 is disposed so as to reciprocate in such directions as to increase and decrease the volume of the pressurizing chamber 11.

The plunger 2 has a large-diameter portion 2a and a small-diameter portion 2b. When the plunger 2 reciprocates, the large-diameter portion 2a and the small-diameter portion 2b are positioned in the auxiliary chamber 17a. Therefore, the volume of the auxiliary chamber 17a increases and decreases along with the reciprocation of the plunger 2.

The auxiliary chamber 17a communicates with a low-pressure fuel chamber 10 through a fuel path 10c (see FIG. 4). When the plunger 2 descends, the fuel flows from the auxiliary chamber 17a to the low-pressure fuel chamber 10. When the plunger 2 ascends, the fuel flows from the low-pressure fuel chamber 10 to the auxiliary chamber 17a. This can reduce the flow rate of the fuel into or out of the pump, in the suction stroke or the return stroke of the high-pressure fuel supply pump 100. This can result in reduction of the pressure pulsation generated in the high-pressure fuel supply pump 100.

As illustrated in FIG. 3, the low-pressure fuel chamber 10 is provided on an upper portion of the body 1 in the high-pressure fuel supply pump 100. A suction joint 5 is attached to a side surface portion of the low-pressure fuel chamber 10. The suction joint 5 is connected to the low-pressure pipe 104, which causes the fuel supplied from the fuel tank 103 to pass therethrough. The fuel in the fuel tank 103 is supplied through the suction joint 5 to the inside of the high-pressure fuel supply pump 100.

The suction joint 5 includes a low-pressure fuel suction port 51 connected to the low-pressure pipe 104, and a suction flow path 52 communicating with the low-pressure fuel suction port 51. A suction filter 53 is disposed in the suction flow path 52. The suction filter 53 removes foreign substances existing in the fuel, thereby preventing these foreign substances from entering the high-pressure fuel supply pump 100.

The low-pressure fuel chamber 10 is covered with a damper cover 14. The low-pressure fuel chamber 10 is provided with a low-pressure fuel flow path 10a, and the suction path 10b. The suction path 10b communicates with the suction port 31b (see FIG. 2) in the electromagnetic suction-valve mechanism 3. The fuel having passed through the low-pressure fuel flow path 10a reaches the suction port 31b in the electromagnetic suction-valve mechanism 3, through the suction path 10b.

The pressure pulsation reduction mechanism 9 is provided in the low-pressure fuel flow path 10a. If the fuel flowed into the pressurizing chamber 11 is returned to the suction path 10b (see FIG. 2) by passing, again, through the electromagnetic suction-valve mechanism 3 in the valve-opened state, pressure pulsation occurs in the low-pressure fuel chamber 10. The pressure pulsation reduction mechanism 9 reduces spreading of pressure pulsation having occurred in the high-pressure fuel supply pump 100 to the low-pressure pipe 104.

The pressure pulsation reduction mechanism 9 includes a metal diaphragm damper constituted by two corrugated disk-shaped metal plates attached to each other at their outer peripheries. The metal diaphragm damper interiorly contains an inert gas such as argon. The metal diaphragm damper expands and contracts to absorb or reduce pressure pulsation.

As illustrated in FIGS. 2 and 4, the electromagnetic suction-valve mechanism 3 is inserted in a lateral hole formed in the body 1. The lateral hole is provided upstream of the pressurizing chamber 11 (closer to the suction path 10b). The electromagnetic suction-valve mechanism 3 includes a suction-valve seat 31 press-fitted in the lateral hole formed in the body 1, the suction valve 32, a suction-valve biasing spring 34, an electromagnetic coil 35, and an anchor 36.

The suction-valve seat 31 is formed in a tubular shape. The suction-valve seat 31 is provided with a seating portion 31a, in its inner peripheral portion. The suction-valve seat 31 is provided with a suction port 31b that reaches an inner peripheral portion from an outer peripheral portion. The suction port 31b communicates with the suction path 10b in the low-pressure fuel chamber 10 described above.

The suction valve 32 includes a rod portion 32a and a valve portion 32b. The rod portion 32a is formed in a columnar shape. The valve portion 32b is provided at one end of the rod portion 32a. The other end of the rod portion 32a faces the anchor 36. The valve portion 32b faces the seating portion 31a of the suction-valve seat 31.

The suction-valve seat 31 has a rod guide 31c (see FIG. 4) through which the rod portion 32a penetrates. The rod guide 31c is formed in a tubular shape. The rod guide 31c is provided with a communication path penetrating the rod guide 31c in the axial direction, beside a tubular hole through which the rod portion 32a penetrates. Consequently, when the anchor 36 moves in the axial direction, the movement of the fuel in the electromagnetic suction-valve mechanism 3 is not obstructed.

In the lateral hole formed in the body 1, there is disposed a stopper 37 (see FIG. 4) which faces the seating portion 31a of the suction-valve seat 31. The valve portion 32b of the suction valve 32 is disposed between the stopper 37 and the seating portion 31a.

When the valve portion 32b comes in contact with the seating portion 31a, the valve portion 32b closes the communicating portion between the suction port 31b and the pressurizing chamber 11. As a result, the electromagnetic suction-valve mechanism 3 is brought into a valve-closed state. On the other hand, when the valve portion 32b comes in contact with the stopper 37, the valve portion 32b opens the communicating portion between the suction port 31b and the pressurizing chamber 11. As a result, the electromagnetic suction-valve mechanism 3 is brought into a valve-opened state.

The suction-valve biasing spring 34 is in contact, at its one end, with a flange provided in the rod portion 32a of the suction valve 32. The suction-valve biasing spring 34 is in contact, at the other end thereof, with the rod guide 31c in the suction-valve seat 31. The suction-valve biasing spring 34 biases the suction valve 32 in a direction in which the valve portion 32b approaches the seating portion 31a of the suction-valve seat 31. Hereinafter, the direction in which the valve portion 32b approaches the seating portion 31a will be defined as a valve closing direction.

The anchor 36 is formed in a substantially cylindrical shape. The anchor 36 comes in contact, at its one end in the axial direction, with the rod portion 32a of the suction valve 32. The anchor 36 faces a fixed core 39, at its other end in the axial direction. The fixed core 39 is formed in a cylindrical shape. The fixed core 39 faces, at its one end in the axial direction, the other end of the anchor 36 in the axial direction.

An anchor guide 33 is fitted to the other end portion of the fixed core 39 in the axial direction. The anchor guide 33 is formed in a columnar shape. The anchor guide 33 includes a large-diameter portion fitted to the inner peripheral portion of the fixed core 39, and a small-diameter portion having a diameter smaller than that of the large-diameter portion. The small-diameter portion of the anchor guide 33 protrudes from the one end, in the axial direction, of the fixed core 39. The anchor 36 is slidably fitted to the small-diameter portion of the anchor guide 33.

An anchor biasing spring 40 is fitted on the outer peripheral portion of the small-diameter portion of the anchor guide 33. The anchor biasing spring 40 is in contact, at its one end, with the other end, in the axial direction, of the anchor 36. The anchor biasing spring 40 is in contact, at the other end thereof, with the large-diameter portion of the anchor guide 33.

The anchor biasing spring 40 biases the anchor 36 in a direction in which the anchor 36 gets away from the fixed core 39. Hereinafter, the direction in which the anchor 36 gets away from the fixed core 39 will be referred to as a valve opening direction. The biasing force of the anchor biasing spring 40 in the valve opening direction is larger than the biasing force of the suction-valve biasing spring 34 in the valve closing direction.

The electromagnetic coil 35 is disposed so as to encircle the fixed core 39. The electromagnetic coil 35 is made of a copper wire wound around a bobbin a plurality of times. A terminal member 30 (see FIG. 2) is electrically connected to the electromagnetic coil 35. An electric current flows through the electromagnetic coil 35 via the terminal member 30.

In a non-energization state where no electric current flows through the electromagnetic coil 35, the anchor 36 is biased in the valve opening direction by the biasing force of the anchor biasing spring 40. Consequently, the anchor 36 presses the suction valve 32 in the valve opening direction. As a result, the valve portion 32b of the suction valve 32 is separated from the seating portion 31a and comes in contact with the stopper 37. Therefore, the electromagnetic suction-valve mechanism 3 is in the valve-opened state. Namely, the electromagnetic suction-valve mechanism 3 is of a normally open type adapted to open in the non-energization state.

When the electromagnetic suction-valve mechanism 3 is in the valve-opened state, the fuel in the suction port 31b passes between the suction valve 32 and the seating portion 31a, then passes through a plurality of fuel passing holes (not illustrated) in the stopper 37 and the suction path 1d, and flows into the pressurizing chamber 11. When the electromagnetic suction-valve mechanism 3 is in the valve-opened state, the valve portion 32b of the suction valve 32 comes in contact with the stopper 37, which restricts the position of the suction valve 32 in the valve opening direction. When the electromagnetic suction-valve mechanism 3 is in the valve-opened state, the gap between the valve portion 32b of the suction valve 32 and the seating portion 31a corresponds to the distance by which the suction valve 32 is movable, which is a valve opening stroke.

When an electric current flows through the electromagnetic coil 35, a magnetic flux is generated. The generated magnetic flux passes through the fixed core 39, the anchor 36, and the like as a magnetic path. Further, magnetic attraction forces act on the magnetic attraction surfaces (the facing surfaces) of the anchor 36 and the fixed core 39. As a result, the anchor 36 moves in the valve closing direction against the biasing force of the anchor biasing spring 40, and comes into contact with the fixed core 39.

When the anchor 36 has moved in the valve closing direction, the suction valve 32 is released from the biasing force of the anchor biasing spring 40 in the valve opening direction. Further, the suction valve 32 moves in the valve closing direction due to the biasing force of the suction-valve biasing spring 34 and the fluid force caused by the fuel flowing into the suction path 10b. This causes the valve portion 32b of the suction valve 32 to come into contact with the seating portion 31a of the suction-valve seat 31. As a result, the electromagnetic suction-valve mechanism 3 is brought into a valve-closed state.

As illustrated in FIG. 4, the discharge-valve mechanism 8 is connected to an outlet side of the pressurizing chamber 11. The discharge-valve mechanism 8 is housed in a discharge-valve chamber 80 formed in the body 1. The discharge-valve mechanism 8 includes a discharge-valve seat 81 having a through hole communicating with the pressurizing chamber 11, a valve body 82 that comes into contact with and separates from the discharge-valve seat 81, a discharge-valve spring 83 that biases the valve body 82 toward the discharge-valve seat 81, and a discharge-valve stopper 84 that determines a stroke (moving distance) of the valve body 82.

Further, the discharge-valve mechanism 8 includes a plug 85 for blocking leakage of the fuel to the outside. The discharge-valve stopper 84 is press-fitted in the plug 85. The plug 85 is bonded to the body 1 by welding at a welding portion 86.

The discharge-valve chamber 80 is a substantially columnar-shaped space extending in a horizontal direction. The discharge-valve chamber 80 communicates, at its one end, with the pressurizing chamber 11. The discharge-valve chamber 80 opens, at the other end thereof, to the side surface of the body 1. The opening at the other end of the discharge-valve chamber 80 is sealed by the discharge-valve stopper 84.

A discharge joint 12 is bonded to the body 1 at a welding portion 12b. The discharge joint 12 has a fuel discharge port 12a. The fuel discharge port 12a communicates with the discharge-valve chamber 80 through a discharge path 87. The discharge path 87 extends in a horizontal direction inside the body 1. The fuel discharge port 12a is connected to the common rail 106 (see FIG. 1).

In a state where the fuel pressure in the pressurizing chamber 11 is lower than the fuel pressure in the discharge-valve chamber 80, the valve body 82 is in press-contact with the discharge-valve seat 81 due to the force of the differential pressure acting on the valve body 82, and the biasing force of the discharge-valve spring 83. As a result, the discharge-valve mechanism 8 is in a valve-closed state. On the other hand, if the fuel pressure in the pressurizing chamber 11 becomes larger than the fuel pressure in the discharge-valve chamber 80, and the force of the differential pressure acting on the valve body 82 becomes larger than the biasing force of the discharge-valve spring 83, the valve body 82 is separated from the discharge-valve seat 81. As a result, the discharge-valve mechanism 8 is brought into a valve-opened state.

When the discharge-valve mechanism 8 has been brought into the valve-opened state, the fuel in the pressurizing chamber 11 is discharged to the common rail 106 (see FIG. 1), through the discharge-valve chamber 80, the discharge path 87, and the fuel discharge port 12a in the discharge joint 12. With the aforementioned configuration, the discharge-valve mechanism 8 functions as a check valve for restricting the direction of flow of the fuel.

As illustrated in FIG. 2, the relief-valve mechanism 4 is disposed in the second chamber 1b in the body 1. The second chamber 1b in the body 1 communicates with the pressurizing chamber 11 and the discharge joint 12. The relief-valve mechanism 4 opens, if some problem occurs in the common rail 106 (see FIG. 1) or a member ahead of the common rail so that the pressure in the common rail 106 exceeds a predetermined pressure. As a result, the fuel in the common rail 106 returns to the pressurizing chamber 11 through the discharge joint 12 and the relief-valve mechanism 4.

### [Operations of the High-Pressure Fuel Supply Pump]

Next, operations of the high-pressure fuel supply pump 100 will be described with reference to FIG. 2.

Referring to FIG. 2, when the plunger 2 descends, if the electromagnetic suction-valve mechanism 3 is opened, the fuel flows through the suction path 1d into the pressurizing chamber 11. Hereinafter, the stroke of descending of the plunger 2 will be referred to as a suction stroke. On the other hand, when the plunger 2 ascends, if the electromagnetic suction-valve mechanism 3 is closed, the fuel in the pressurizing chamber 11 is raised in pressure. Consequently, the fuel in the pressurizing chamber 11 is pressure-fed to the common rail 106 (see FIG. 1), by passing through the discharge-valve mechanism 8 (see FIG. 4). Hereinafter, the stroke of ascending of the plunger 2 will be referred to as a compression stroke.

During the compression stroke, if the electromagnetic suction-valve mechanism 3 is closed, the fuel sucked into the pressurizing chamber 11 during the suction stroke is pressurized and discharged toward the common rail 106. On the other hand, during the compression stroke, if the electromagnetic suction-valve mechanism 3 is opened, the fuel in the pressurizing chamber 11 is pushed back toward the suction path 1d and is not discharged toward the common rail 106. In this manner, the discharge of the fuel by the high-pressure fuel supply pump 100 is manipulated by opening and closing the electromagnetic suction-valve mechanism 3. The opening and closing of the electromagnetic suction-valve mechanism 3 is controlled by the ECU101.

During the suction stroke, the volume of the pressurizing chamber 11 increases, thereby decreasing the fuel pressure in the pressurizing chamber 11. Consequently, the fuel pressure in the pressurizing chamber 11 becomes lower than the fuel pressure in the suction port 31b. Further, if the biasing force due to the differential pressure therebetween exceeds the biasing force of the valve biasing spring 38, the suction valve 32 is separated from the seating portion 31a. Consequently, the electromagnetic suction-valve mechanism 3 is brought into the valve-opened state. As a result, the fuel in the suction port 31b passes between the suction valve 32 and the seating portion 31a, passes through the plurality of holes provided in the stopper 37, and flows into the pressurizing chamber 11.

After the completion of the suction stroke, shift to the compression stroke occurs. At this time, the electromagnetic coil 35 remains in the non-energization state, and no magnetic attraction force acts between the anchor 36 and the fixed core 39. Further, a biasing force in the valve opening direction, which corresponds to the difference in biasing force between the anchor biasing spring 40 and the rod biasing spring 34, is applied to the suction valve 32. Further, a fluid force (pressing force in the valve closing direction) generated by the fuel flowing back from the pressurizing chamber 11 to the low-pressure fuel flow path 10a is applied to the suction valve 32.

In this state, in order to maintain the electromagnetic suction-valve mechanism 3 in the valve-opened state, the difference in biasing force between the anchor biasing spring 40 and the rod biasing spring 34 is set to be larger than the fluid force. The volume of the pressurizing chamber 11 decreases as the plunger 2 ascends. Therefore, the fuel having been sucked into the pressurizing chamber 11 is returned to the suction port 31b, by passing between the suction valve 32 and the suction-valve seat 31. Therefore, the fuel pressure in the pressurizing chamber 11 is not increased. This stroke is referred to as a return stroke.

During the return stroke, if a control signal from the ECU101 (see FIG. 1) is applied to the electromagnetic suction-valve mechanism 3, an electric current flows through the electromagnetic coil 35 via the terminal member 30. When the electric current flows through the electromagnetic coil 35, a magnetic attraction force acts on the magnetic attraction surfaces of the fixed core 39 and the anchor 36, so that the anchor 36 is attracted to the fixed core 39.

Then, if the magnetic attraction force becomes larger than the biasing force of the anchor biasing spring 40, the anchor 36 moves toward the fixed core 39 (in the valve closing direction), against the biasing force of the anchor biasing spring 40. Consequently, the anchor 36 moves in the direction away from the suction valve 32. As a result, the valve portion 32b of the suction valve 32 is seated on the seating portion 31a, due to the biasing force of the suction-valve biasing spring 34, and the fluid force generated by the fuel flowing into the suction path 10b. When the suction valve 32 has been seated on the seating portion 31a, the electromagnetic suction-valve mechanism 3 is in the valve-closed state.

After the electromagnetic suction-valve mechanism 3 has been brought into the valve-closed state, the fuel in the pressurizing chamber 11 is raised in pressure as the plunger 2 ascends. If the pressure of the fuel in the pressurizing chamber 11 becomes equal to or higher than a predetermined pressure, the fuel in the pressurizing chamber 11 passes through the discharge-valve mechanism 8 (see FIG. 4) and is discharged to the common rail 106 (see FIG. 1). This stroke is referred to as a discharge stroke. Namely, the compression stroke between the lower start point and the upper start point of the plunger 2 is constituted by the return stroke and the discharge stroke. By controlling the timing of energizing the electromagnetic coil 35 in the electromagnetic suction-valve mechanism 3, it is possible to control the amount of high-pressure fuel to be discharged.

If the timing of energizing the electromagnetic coil 35 is made earlier, the rate of the return stroke during the compression stroke becomes smaller, while the rate of the discharge stroke becomes larger. As a result, the amount of the fuel returned to the suction path 10b is made smaller, while the amount of the fuel discharged at a high pressure is made larger. On the other hand, if the timing of energizing the electromagnetic coil 35 is made later, the rate of the return stroke during the compression stroke becomes larger, while the rate of the discharge stroke becomes smaller. As a result, the amount of the fuel returned to the suction path 10b is made larger, while the amount of the fuel discharged at a high pressure is made smaller. As described above, by controlling the timing of energizing the electromagnetic coil 35, it is possible to control the amount of the fuel discharged at a high pressure to an amount required by the engine (internal combustion engine).

### [The Relief-Valve Mechanism]

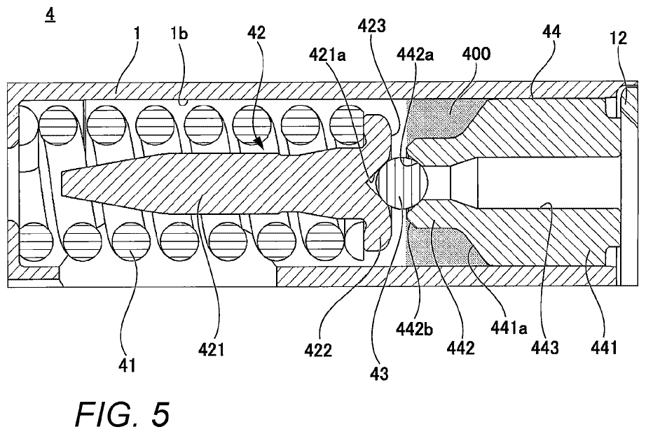

Next, the configuration of the relief-valve mechanism 4 will be described with reference to FIG. 5.

FIG. 5 is an enlarged view of the relief-valve mechanism 4.

As illustrated in FIG. 5, the relief-valve mechanism 4 includes a relief spring 41, a relief-valve holder 42, a relief valve (valve body) 43, and a seat member 44.

The seat member 44 has a shape constituted by two cylinders with different diameters which are continuous in the axial direction, and includes a fitting portion 441, a seat portion 442, and a fuel path 443 penetrating the fitting portion 441 and the seat portion 442 in the axial direction. The seat member 44 has an axial direction substantially parallel to the axial direction of the second chamber 1b (housing hole).

The fuel path 443 has a circular-shaped cross section orthogonal to the axial direction of the seat member 44. The fuel path 443 communicates with the discharge joint 12. The fuel path 443 causes the fuel flowing from the discharge joint 12 to pass therethrough.

The fitting portion 441 is larger in diameter than the seat portion 442. The fitting portion 441 is positioned closer to the discharge joint 12, and the seat portion 442 is positioned closer to the pressurizing chamber 11. The fitting portion 441 is fitted to the inner peripheral surface of the second chamber 1b to be in intimate contact therewith. Between the fitting portion 441 and the seat portion 442, there is formed a tapered portion 444 with a diameter gradually decreasing with decreasing distance to the seat portion 442. The tapered portion 444 and the seat portion 442 form an enlarged space 400 between them and the inner wall surface of the second chamber 1b.

The seat portion 442 is provided with a seat surface 442a at its end portion opposite from the fitting portion 441. The seat surface 442a is such a tapered surface as to gradually increase the diameter of the fuel path 443 with decreasing distance to the end surface of the seat portion 442. The seat surface 442a of the seat portion 442 faces the relief valve 43. The seat portion 442 is provided, in its outer peripheral portion, with a tapered surface 442b with a diameter gradually decreasing with increasing distance from the fitting portion 441. The seat portion 442 has a tip end formed to have a curved surface, on the opposite side from the fitting portion 441 (on its side closer to the relief-valve holder 42). The tapered surface 442b is continuous with the curved surface at the tip end of the seat portion 442.

The relief valve 43 is formed to be a spherical body. The relief-valve holder 42 includes a holder body 421 and a flange portion 422. The holder body 421 is formed in a substantially columnar shape. The holder body 421 faces, at its one end in the axial direction, the seat portion 442 of the seat member 44. The holder body 421 is provided with a valve engagement recess portion 421a, in its one end in the axial direction. The relief valve 43 is engaged with the valve engagement recess portion 421a. Thus, the relief-valve holder 42 holds the relief valve 43.

The flange portion 422 protrudes radially outward from the one end of the holder body 421 in the axial direction. A gap is formed between the outer peripheral surface of the flange portion 422 and the inner wall surface of the second chamber 1b. The flange portion 422 has a corner portion chamfered to be rounded, on its side closer to the seat member 44. The flange portion 422 has an end surface forming the same plane as that of the end surface of the holder body 421, on its side closer to the seat member 44. Hereinafter, the end surface of the flange portion 422 on its side closer to the seat member 44, and the end surface of the holder body 421 will be simply referred to as the end surface 423 of the relief-valve holder 42.

The relief spring 41 is a compression coil spring. The relief spring 41 is in contact, at its one end portion, with the body 1 which forms the bottom portion of the second chamber 1b. The relief spring 41 is in contact, at the other end portion thereof, with the flange portion 422 of the relief-valve holder 42. The holder body 421 in the relief-valve holder 42 is inserted in the inside of the relief spring 41.

The relief spring 41 biases the relief-valve holder 42 toward the seat member 44. Therefore, the relief spring 41 biases the relief valve 43 toward the seat member 44 with the relief-valve holder 42 interposed therebetween. Accordingly, the relief valve 43 is in contact (intimate contact) with the seat surface 442a of the seat portion 442, thereby closing the fuel path 443.

If the pressure of the fuel in the common rail 106 (see FIG. 1) or in a member ahead thereof increases so that the pressure of the fuel in the fuel path 443 exceeds a predetermined pressure, the fuel in the fuel path 443 presses the relief valve 43 with a pressing force larger than the biasing force of the relief spring 41. Consequently, the relief valve 43 and the relief-valve holder 42 move in the direction away from the seat surface 442a, against the biasing force of the relief spring 41. As a result, the relief-valve mechanism 4 opens, and the fuel in the discharge joint 12 returns to the pressurizing chamber 11 through the fuel path 443 in the seat member 44. Therefore, the pressure which causes the relief valve 43 to open is determined by the biasing force of the relief spring 41.

Although the relief-valve mechanism 4 according to the present embodiment communicates with the pressurizing chamber 11, the relief-valve mechanism is not limited thereto. The relief-valve mechanism according to the present invention may also communicate with, for example, a low-pressure path (the low-pressure fuel suction port 51, the suction path 10b, or the like).

### [Relationship Between the Relief-Valve Holder and the Enlarged Space]

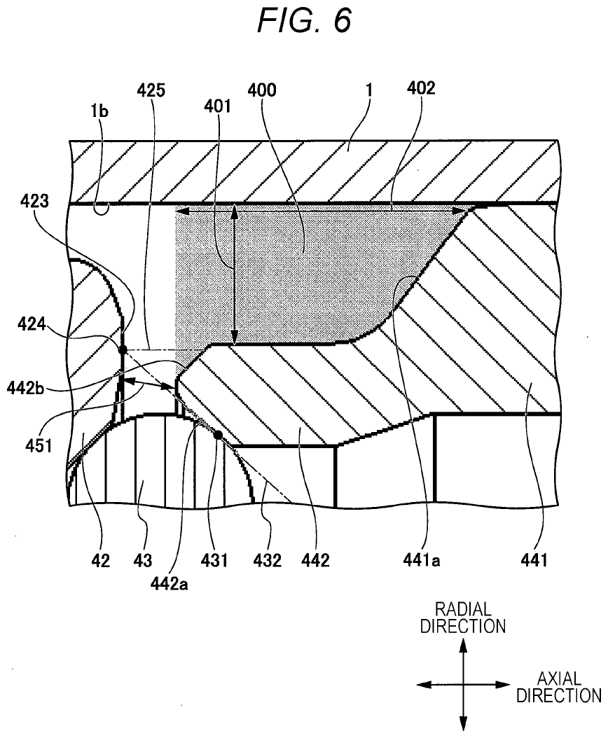

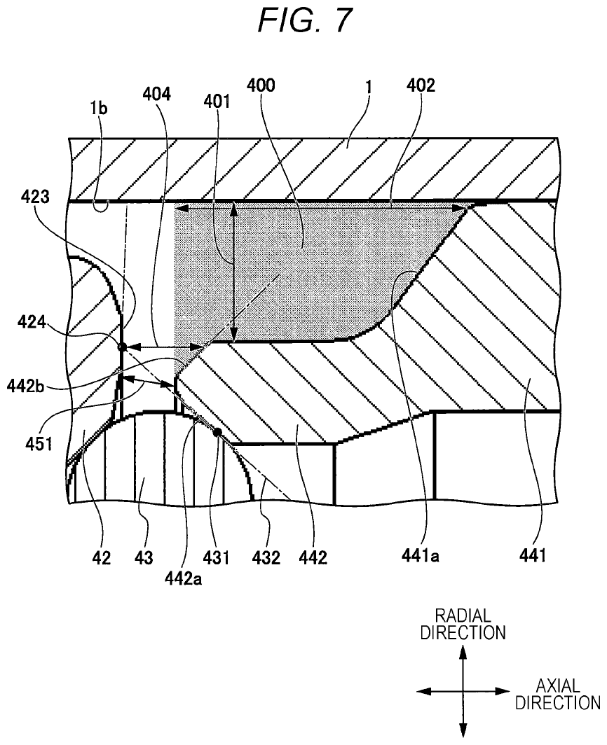

Next, there will be described the relationship between the relief-valve holder 42 in the relief-valve mechanism 4 and the enlarged space 400, with reference to FIGS. 6 and 7.

FIGS. 6 and 7 are enlarged views of the vicinity of the seat portion 442 in the relief-valve mechanism 4.

In recent years, the fuel pressure in the high-pressure fuel supply pump has been increased, which has been inducing large reduction in the fuel pressure in the vicinity of the seat surface 442a of the seat portion 442 in the relief-valve mechanism 4. This has tended to generate cavitation in the vicinity of the seat surface 442a. This has resulted in a tendency to generate erosion in the seat surface 442a, which has made it difficult to maintain the sealing property of the relief-valve mechanism 4 in long-term use.

In the present embodiment, there is provided the enlarged space 400 for collapsing cavitation therein, radially outside the seat portion 442 in the seat member 44. The relief-valve holder 42 guides, to the enlarged space 400, flows of the fuel and cavitation flowing out of the seat portion 442. Consequently, the cavitation can be retained and collapsed in the enlarged space 400.

As illustrated in FIG. 6, a distance 401 in the enlarged space 400 in the radial direction of the second chamber 1b (housing hole) is longer than a shortest distance 451 between the seat member 44 and the relief-valve holder 42. The shortest distance 451 is a distance from the outer peripheral surface of the seat portion 442 in the seat member 44 to the inner wall surface of the second chamber 1b. Further, a distance 402 in the enlarged space 400 in the axial direction of the second chamber 1b is longer than the shortest distance 451 between the seat member 44 and the relief-valve holder 42. Incidentally, the distance 402 is a distance from the end surface of the seat portion 442 in the seat member 44 to the end portion of the tapered portion 441a closer to the fitting portion 441.

In a state where the seat surface 442a of the seat portion 442 and the relief valve 43 are in contact with each other to close the relief-valve mechanism 4, it is assumed that the relief valve 43 is in contact with the seat surface 442a at a point 431 (actually, line contact), and a tangential line 432 passing through this point 431 intersects with the end surface 423 of the relief-valve holder 42 at an intersection point 424. A line 425 extending from the intersection point 424 in the axial direction of the second chamber 1b passes through the enlarged space 400 until reaching the surface of the seat member 44.

Since the enlarged space 400 is secured radially outside the seat member 44, and the relief-valve holder 42 and the seat member 44 are formed in such a way as to satisfy the condition illustrated in FIG. 6, the end surface 423 of the relief-valve holder 42 can guide the fuel flowing out of the seat portion 442 to the enlarged space 400. Thus, a cavitation generated around the seat surface 442a of the seat portion 442 can be guided and introduced into the enlarged space 400. Then, the cavitation can be collapsed in the enlarged space 400. As a result, it is possible to suppress the occurrence of erosion on the seat surface 442a. Therefore, it is possible to secure the sealing property of the relief-valve mechanism 4 for a long time period.

As illustrated in FIG. 7, in the region radially outside the intersection point 424, the end surface 423 of the relief-valve holder 42 is inclined so as to gradually get closer to the enlarged space 400 as being more outside radially. Further, in the region radially outside the intersection point 424, the distance 452 between the end surface 423 of the relief-valve holder 42 and the seat member 44 gradually increases as being more outside radially.

Since the enlarged space 400 is secured radially outside of the seat member 44, and the relief-valve holder 42 and the seat member 44 are formed in such a way as to satisfy the condition illustrated in FIG. 7, the end surface 423 of the relief-valve holder 42 can guide the fuel flowing out of the seat portion 442 to the enlarged space 400. Thus, a cavitation can be collapsed in the enlarged space 400. As a result, it is possible to suppress the occurrence of erosion on the seat surface 442a. Therefore, it is possible to secure the sealing property of the relief-valve mechanism 4 for a long time period.

Further, the seat portion 442 of the seat member 44 is provided, in its outer peripheral portion, with the tapered surface 442b having a diameter gradually decreasing with decreasing distance to the relief-valve holder 42. Consequently, the fuel being guided toward the enlarged space 400 by the end surface 423 of the relief-valve holder 42 is not hindered from travelling.

The seat portion 442 has the tip end formed to have a curved surface, on its side closer to the relief-valve holder 42. Consequently, the fuel flowing out of the seat portion 442 can easily get over the seat portion 442 to travel toward the enlarged space 400. Further, it is possible to suppress the occurrence of erosion at the tip end of the seat portion 442.

The seat portion 442 has a columnar portion facing the enlarged space 400 in the radial direction of the second chamber 1b (housing hole). This enables making the enlarged space 400 larger. In addition, since the columnar portion has no protruding portion protruding radially outward, the columnar portion is not likely to interfere with cavitation guided to the enlarged space 400. As a result, it is possible to suppress the occurrence of erosion in the columnar portion (the outer peripheral portion of the seat portion 442).

The flange portion 422 of the relief-valve holder 42 has the corner portion chamfered to be rounded, on its side closer to the seat member 44. Consequently, the fuel flowing toward the pressurizing chamber 11 can easily get over the relief-valve holder 42.

The seat member 44 has the tapered portion 444 between the fitting portion 441 and the seat portion 442. This makes it possible to make the distance 402 in the enlarged space 400 in the axial direction of the second chamber 1b larger. As a result, it is possible to make the enlarged space 400 larger, while securing rigidity of the seat member 44.

The present invention is not limited to the embodiment described above and illustrated in the drawings, and various modifications can be made thereto without departing from the gist of the invention described in the claims.

For example, the aforementioned embodiment has been described in detail for facilitating understanding the present invention, and the present invention is not necessarily limited to the configuration including all the described configurations. Further, the configuration according to one embodiment can be partially replaced with the configuration according to another embodiment, and, also, the configuration according to one embodiment can be additionally provided with the configuration according to another embodiment. Further, the configuration according to each embodiment can be partially provided with other additional configurations, eliminated or replaced with other configurations.

In the present embodiment, the relief-valve mechanism 4 has been described as a specific example of a valve mechanism according to the present invention. However, the valve mechanism according to the present invention is not limited to the relief-valve mechanism, and may be another valve mechanism such as a discharge-valve mechanism, for example.

### REFERENCE SIGNS LIST

1 body
1a suction path
1b flange
1c fixing portion
2 plunger
3 electromagnetic suction valve
4 relief-valve mechanism
5 suction joint
6 cylinder
8 discharge valve
9 pressure pulsation reduction mechanism
10 low-pressure fuel chamber
11 pressurizing chamber
12 discharge joint
41 relief spring
42 relief-valve holder
43 relief valve
44 seat member
100 high-pressure fuel supply pump
400 enlarged space
421 holder body
421a valve engagement recess portion
422 flange portion
423 end surface
424 intersection point
431 point
432 tangential line
441 fitting portion
441a tapered portion
442 seat portion
442a seat surface
442b tapered surface
443 fuel path

1. A valve mechanism disposed in a housing hole for passing a fuel therethrough, the valve mechanism comprising:
a seat member including a fitting portion in intimate contact with an inner wall surface of the housing hole, a seat portion forming an enlarged space between the seat portion and the inner wall surface of the housing hole, and a fuel path penetrating the fitting portion and the seat portion for causing the fuel to pass therethrough;
a valve body adapted to face the seat portion and to open and close the fuel path;
a valve holder adapted to hold the valve body; and
a spring adapted to bias the valve body toward the seat member with the valve holder interposed therebetween;
wherein a distance in the enlarged space in a radial direction of the housing hole, and a distance in the enlarged space in an axial direction of the housing hole are longer than a shortest distance between the seat portion and the valve holder, and
in a state where the valve body is in contact with the seat portion by being biased by the spring, a tangential line passing through a point at which the valve body contacts the seat portion intersects with the valve holder at an intersection point, and a line extended in the axial direction of the housing hole from the intersection point passes through the enlarged space until the line reaches a surface of the seat member.

2. A valve mechanism disposed in a housing hole for passing a fuel therethrough, the valve mechanism comprising:
a seat member including a fitting portion in intimate contact with an inner wall surface of the housing hole, a seat portion forming an enlarged space between the seat portion and the inner wall surface of the housing hole, and a fuel path penetrating the fitting portion and the seat portion for causing the fuel to pass therethrough;
a valve body adapted to face the seat portion and to open and close the fuel path;
a valve holder adapted to hold the valve body; and
a spring adapted to bias the valve body toward the seat member with the valve holder interposed therebetween;
wherein a distance in the enlarged space in a radial direction of the housing hole, and a distance in the enlarged space in an axial direction of the housing hole are longer than a shortest distance between the seat portion and the valve holder,
a tangential line passing through a point at which the valve body contacts the seat portion intersects with the valve holder at an intersection point, and outside the intersection point in the radial direction of the housing hole, an end surface of the valve holder closer to the enlarged space is inclined toward the seat member, and a distance between this end surface and the seat member gradually increases as being more outside in the radial direction of the housing hole.

3. The valve mechanism according to claim 1, wherein the seat portion is provided, in the outer peripheral portion, with a tapered surface having a diameter gradually decreasing with decreasing distance to the valve holder.

4. The valve mechanism according to claim 1, wherein the seat portion has a tip end formed to have a curved surface.

5. The valve mechanism according to claim 1, wherein the seat portion has a columnar portion facing the enlarged space.

6. The valve mechanism according to claim 1, wherein the valve holder has a corner portion chamfered to be rounded, on its side closer to the seat member.

7. A fuel pump comprising a body with a housing hole for passing a fuel therethrough, and a valve mechanism disposed in the housing hole;
the valve mechanism including:
a seat member including a fitting portion in intimate contact with an inner wall surface of the housing hole, a seat portion forming an enlarged space between the seat portion and the inner wall surface of the housing hole, and a fuel path penetrating the fitting portion and the seat portion for causing the fuel to pass therethrough;
a valve body adapted to face the seat portion and to open and close the fuel path;
a valve holder adapted to hold the valve body; and
a spring adapted to bias the valve body toward the seat member with the valve holder interposed therebetween,
wherein a distance in the enlarged space in a radial direction of the housing hole, and a distance in the enlarged space in an axial direction of the housing hole are longer than a shortest distance between the seat portion and the valve holder, and
in a state where the valve body is in contact with the seat portion by being biased by the spring, a tangential line passing through a point at which the valve body contacts the seat portion intersects with the valve holder at an intersection point, and a line extended in the axial direction of the housing hole from the intersection point passes through the enlarged space until the line reaches a surface of the seat member.

8. A fuel pump comprising a body with a housing hole for passing a fuel therethrough, and a valve mechanism disposed in the housing hole;
the valve mechanism including:
a seat member including a fitting portion in intimate contact with an inner wall surface of the housing hole, a seat portion forming an enlarged space between the seat portion and the inner wall surface of the housing hole, and a fuel path penetrating the fitting portion and the seat portion for causing the fuel to pass therethrough;
a valve body adapted to face the seat portion and to open and close the fuel path;
a valve holder adapted to hold the valve body; and
a spring adapted to bias the valve body toward the seat member with the valve holder interposed therebetween,
wherein a distance in the enlarged space in a radial direction of the housing hole, and a distance in the enlarged space in an axial direction of the housing hole are longer than a shortest distance between the seat portion and the valve holder,
a tangential line passing through a point at which the valve body contacts the seat portion intersects with the valve holder at an intersection point, and outside the intersection point in the radial direction of the housing hole, an end surface of the valve holder closer to the enlarged space is inclined toward the seat member, and a distance between this end surface and the seat member gradually increases as being more outside in the radial direction of the housing hole.
